(19) United States
(12) Patent Application Publication
(10) Pub. No.: US 2006/0050195 A1
(43) Pub. Date: Mar. 9, 2006

(54) Receiving container for a display device, liquid crystal display device having the receiving container and method of manufacturing the same

(75) Inventors: Jin-Sung Choi, Yongin-si (KR); Jong-Dae Park, Seoul (KR); Jeoung-Gwen Lee, Suwon-si (KR); Dong-Hoon Kim, Seoul (KR)

Correspondence Address: MCGUIREWOODS, LLP, 1750 TYSONS BLVD, SUITE 1800, MCLEAN, VA, 22102, US

(73) Assignee: Samsung Electronics Co., Ltd.

(21) Appl. No.: 11/217,399

(22) Filed: Sep. 2, 2005

(30) Foreign Application Priority Data
Sep. 6, 2004 (KR) 10-2004-0070966

(51) Int. Cl. G02F 1/1333

(52) U.S. Cl. 349/58

(57) ABSTRACT

A receiving container for a display device, an LCD device having the receiving container for the display device, and a method of manufacturing the LCD device, wherein the receiving container for the display device includes a frame and a synthetic rubber spacer. The synthetic rubber spacer is provided on the frame. The synthetic rubber spacer includes a plurality of synthetic rubber pieces connected together so that the synthetic rubber spacer absorbs an externally provided impact and protects the LCD panel.

### CROSS-REFERENCE OF RELATED APPLICATION

The present application claims priority from Korean Patent Application No. 2004-70966, filed on Sep. 6, 2004, which is hereby incorporated by reference for all purposes as if fully set forth herein.

### BACKGROUND OF THE INVENTION

1. Field of the Invention

The present invention relates to a receiving container for a display device, a liquid crystal (LCD) device having the receiving container and a method of manufacturing the display device. More particularly, the present invention relates to a receiving container for a display device, which is capable of protecting the display device, an LCD device having the receiving container, and a method of manufacturing the LCD device, which is capable of decreasing manufacturing time and manufacturing cost.

2. Description of the Related Art

In an LCD device, liquid crystal arrangement generally varies according to an electric field applied thereto, and thus a light transmittance thereof may be changed, thereby displaying an image.

The LCD device includes a backlight assembly, an LCD panel, and a receiving container. The backlight assembly generates a light. The LCD panel converts the light generated from the backlight assembly into the image. The receiving container receives the backlight assembly and the LCD panel.

When the backlight assembly or the LCD panel is not securely fixed in the receiving container, the backlight assembly and/or the LCD panel shifts or moves in the receiving container. In addition, an image display quality of the LCD device is deteriorated by an impurity that is provided from an environment exterior to the LCD device, such as airborne particles.

### SUMMARY OF THE INVENTION

The present invention provides a receiving container for a display device, which is capable of protecting the display device. According to an embodiment of the invention, there is provided a receiving container for a display device including a frame, and a synthetic rubber spacer provided on the frame, wherein the synthetic rubber spacer includes a plurality of synthetic rubber pieces that are connected together.

According to an embodiment of the invention, there is provided a liquid crystal display device including a backlight assembly generating a light, a liquid crystal display panel provided on the backlight assembly that displays an image using the generated light, a receiving container provided between the backlight assembly and the liquid crystal display panel to secure the backlight assembly, the receiving container including a plurality of sidewalls that define an open area of the receiving container, and a synthetic rubber spacer provided between the sidewalls and the liquid crystal display panel to support the liquid crystal display panel, wherein the synthetic rubber spacer includes a plurality of synthetic rubber pieces connected together.

According to an embodiment of the invention, there is provided a liquid crystal display device including a backlight assembly generating a light, a liquid crystal display panel provided on the backlight assembly that displays an image using the generated light, a receiving container, which receives the liquid crystal display panel and the backlight assembly, and includes a plurality of sidewalls that define an open area of the receiving container, and a synthetic rubber spacer provided between the sidewalls and the liquid crystal display panel to support the liquid crystal display panel, wherein the synthetic rubber spacer includes a plurality of synthetic rubber pieces that are connected together.

According to an embodiment of the invention, there is provided a liquid crystal display device including a backlight assembly that generates a light, a liquid crystal display panel provided on the backlight assembly to display an image using the generated light, a receiving container, which receives the backlight assembly and the liquid crystal display panel, and includes a first rod shaped piece and another rod shaped piece corresponding to the first rod shaped piece, a synthetic rubber spacer provided between the first rod shaped piece and the liquid crystal display panel that supports the liquid crystal display panel, and another synthetic rubber spacer provided between the other rod shaped piece corresponding to the first rod shaped piece and the liquid crystal display panel that supports the liquid crystal display panel.

According to an embodiment of the invention, there is provided a method of manufacturing a liquid crystal display device, the method including forming a mold frame on a backlight assembly, the mold frame having a plurality of sidewalls that define an open area of the mold frame, each of the sidewalls having a stepped portion, coating synthetic rubber resin on a lower level surface area of the stepped portion, solidifying the coated synthetic resin, and forming a liquid crystal display device on the solidified synthetic resin.

It is to be understood that both the foregoing general description and the following detailed description are exemplary and explanatory and are intended to provide further explanation of the invention as claimed.

### BRIEF DESCRIPTION OF THE DRAWINGS

The above and other advantages of the present invention will become more apparent by describing in detail exemplary embodiments thereof with reference to the accompanying drawings, in which:

FIG. 1 is an exploded perspective view showing an LCD device in accordance with an embodiment of the invention.

FIG. 2 is a cross-sectional view showing the LCD device shown in FIG. 1.

FIG. 3 is a perspective view showing a method of attaching a rubber tape to a middle mold frame shown in FIG. 1.

FIG. 4 is a perspective view showing a method of coating a silicone resin on a middle mold frame shown in FIG. 1.

FIG. 5 is a cross-sectional view showing a deformation of the silicone resin shown in FIG. 4.

FIG. 6 is a perspective view showing a method of coating a synthetic rubber on a middle mold frame shown in FIG. 1.

FIG. 7 is a plan view showing the coated synthetic rubber in accordance with an embodiment of the invention.

FIG. 8 is a plan view showing the coated synthetic rubber in accordance with another embodiment of the invention.

FIG. 9 is a plan view showing the coated synthetic rubber in accordance with another embodiment of the invention.

FIG. 10 is a cross-sectional view showing the coated synthetic rubber after being pressed by an externally provided impact.

FIG. 11 is an exploded perspective view showing an LCD device in accordance with another embodiment of the invention.

FIG. 12 is a cross-sectional view showing an LCD device shown in FIG. 11.

FIG. 13 is a cross-sectional view showing a mold frame assembly shown in FIG. 11.

FIG. 14 is a perspective view showing a mold frame assembly in accordance with another embodiment of the invention.

FIG. 15 is a perspective view showing an LCD device in accordance with another embodiment of the invention,

FIG. 16 is a cross-sectional view showing an LCD device shown in FIG. 15,

FIG. 17 is a perspective view showing a first piece mold and a first synthetic rubber spacer shown in FIG. 15.

FIG. 18 is a perspective view showing a first piece mold, a first synthetic rubber spacer and a first auxiliary synthetic rubber spacer in accordance with an exemplary embodiment of the present invention.

### DESCRIPTION OF THE EMBODIMENTS

It should be understood that the exemplary embodiments of the present invention described below may be varied modified in many different ways without departing from the inventive principles disclosed herein, and the scope of the present invention is therefore not limited to these particular following embodiments. Rather, these embodiments are provided so that this disclosure will be through and complete, and will fully convey the concept of the invention to those skilled in the art by way of example and not of limitation.

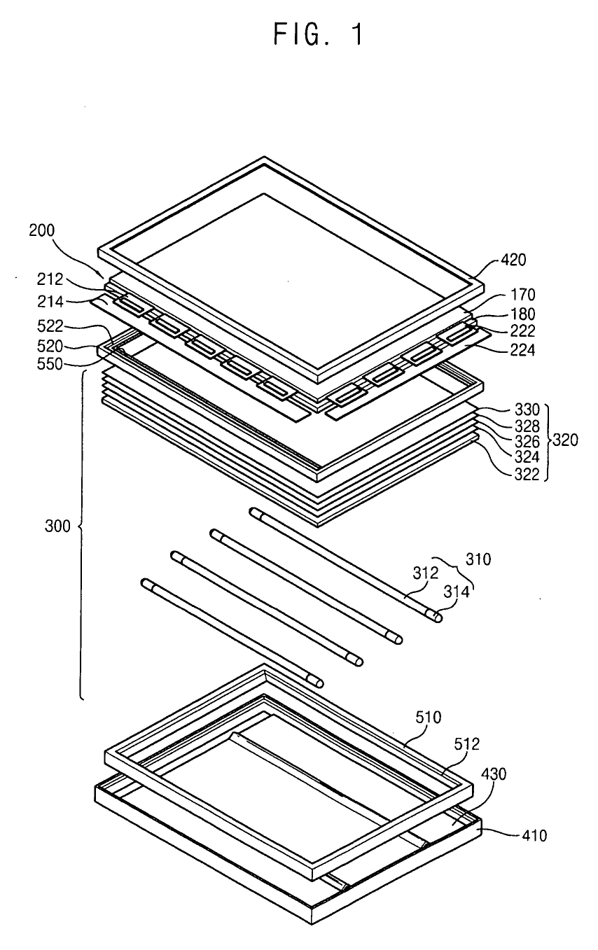

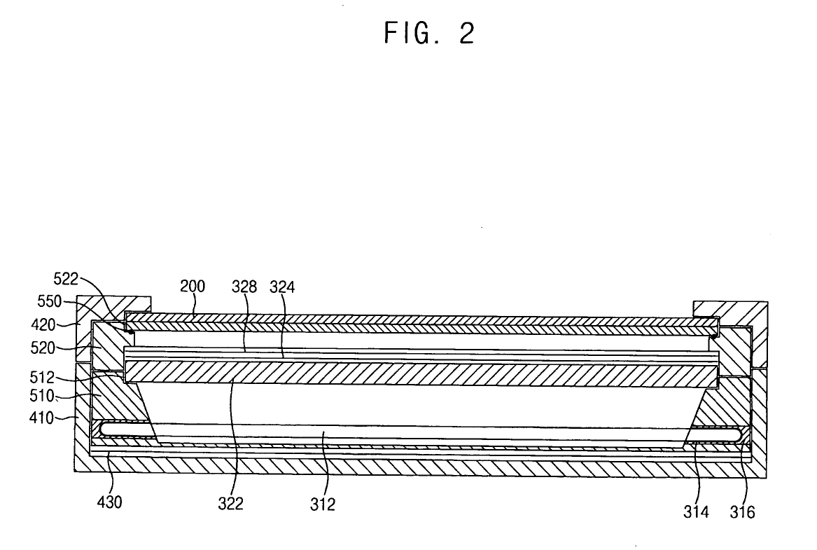

Hereinafter, the present invention will be described in detail with reference to the accompanying drawings. FIG. 1 is an exploded perspective view showing an LCD device according to an embodiment of the invention. FIG. 2 is a cross-sectional view showing the LCD device shown in FIG. 1.

Referring to FIG. 1 and FIG. 2, the LCD device includes an LCD panel 200, a backlight assembly 300, a mold frame assembly, and a chassis assembly. The LCD panel 200 includes a first substrate 170, a second substrate 180, a liquid crystal layer (not shown), a data tape carrier package (TCP) 212, a data printed circuit board (PCB) 214, a gate TCP 222 and a gate PCB 224.

The first substrate 170 includes an upper plate (not shown), a color filter (not shown), and a common electrode (not shown). A light having a predetermined wavelength may pass through the color filter (not shown). A common voltage is applied to the common electrode (not shown).

The second substrate 180 includes a lower plate (not shown), a thin film transistor (TFT) (not shown), a pixel electrode (not shown), a data line (not shown), and a gate line (not shown).

The data line (not shown) is coupled with a source electrode of the TFT (not shown). A data driving chip mounted on the data TCP 212 applies a data signal to the source electrode of the TFT (not shown) through the data TCP 212 and the data line (not shown). Alternatively, the data driving chip may be mounted on or directly on the second substrate 180.

The gate line (not shown) is coupled with a gate electrode of the TFT (not shown). A gate signal is applied by a gate driving chip, located on the gate TCP 222, to the gate electrode of the TFT (not shown) through the gate TCP 222 and the gate line (not shown). Alternatively, the gate driving chip may be mounted directly on the second substrate 180.

The data signal is applied to the pixel electrode (not shown) when the data signal and the gate signal are applied to the source electrode and the gate electrode, respectively, of the TFT (not shown).

The liquid crystal layer (not shown) is provided or sandwiched between the first and second substrates 170 and 180. An arrangement of the liquid crystal layer (not shown) changes when the data signal and the common voltage are applied to the pixel electrode (not shown) and the common electrode (not shown), respectively.

The second substrate 180 is coupled with the data PCB 214 by the data TCP 212, which is provided on the second substrate 180. The data TCP 212 includes a flexible material, which may be bent toward a rear surface of the second substrate 180. According to an embodiment of the invention, the data TCP 212 is bent in a backward fashion so that the data PCB 214 is provided on or directly on the rear surface of the second substrate 180.

The second substrate 180 is coupled with the gate PCB 224 by the gate TCP 22 provided on or directly on the second substrate 180. The gate TCP 222 includes a flexible material that may be bent toward the rear surface of the second substrate 180. Accordingly, the gate TCP 222 may be bent in a backward fashion to position the gate PCB 224 on or directly on the rear surface of the second substrate 180.

The LCD panel 200 may further include an integrated PCB (not shown) that includes the data PCB 214 and the gate PCB 224. When the LCD panel 200 includes the integrated PCB (not shown), the integrated PCB is coupled with the second substrate 180 through an integrated TCP (not shown).

The backlight assembly 300 is provided on or directly on a rear surface of the LCD panel 200. The backlight assembly 300 includes may include a lamp 310, a lamp socket 316 and an optical film assembly 320.

According to an embodiment of the invention, the lamp 310 includes a cold cathode fluorescent lamp (CCFL). The lamp 310 may further include a lamp body 312 and a lamp electrode 314. The lamp body 312 includes a discharge space (not shown), a fluorescent layer (not shown), and a discharge gas (not shown) provided in the discharge space (not shown). The discharge gas includes, for example, a mercury vapor. The lamp electrode 314 is provided on or directly on the lamp body 312. The discharge gas in the discharge space is discharged when a voltage is applied to the lamp electrode 314 so that the discharge space is provided with electrons by the lamp electrode 314. An ultraviolet light is generated when the electrons are combined with the mercury vapor. A visible light is when generated when the ultraviolet light is irradiated onto the fluorescent layer (not shown).

The lamp socket 316 receives the lamp electrode 314 and applies a voltage, which is externally provided, to the lamp electrode 314. In the above described embodiment of the invention, the lamp socket 316 is provided in the low mold frame 510.

The optical film assembly 320 is provided on or directly on the lamp 310 and converts the visible light generated from the lamp 310 into a planar light. The optical film assembly 320 improves optical characteristics of the visible light. The optical film assembly 320 includes at least a diffusion plate 322, a diffusion sheet 324, a lower prism sheet 326, an upper prism sheet 328 and a protecting sheet 330.

The diffusion sheet 324 is provided on or directly on the diffusion plate 322. When the visible light passes through the diffusion sheet 324 and the diffusion plate 322, luminance of the visible light is made uniform.

The lower prism sheet 326 is provided on or directly on the diffusion sheet 324, and the upper prism sheet 328 is provided on or directly on the lower prism sheet 326. When the visible light passes through the lower prism sheet 326 and the upper prism sheet 328, a luminance of the visible light increases when viewed in a plan view of the LCD device.

The protecting sheet 330 is provided on or directly on the upper prism sheet 328 and protects the diffusion plate 322, the diffusion film 324, the lower prism sheet 326, and the upper prism sheet 328.

The chassis assembly includes at least a bottom chassis 410, a top chassis 420, and a reflecting plate 430. The bottom chassis 410 includes at least a bottom plate and a plurality of sidewalls protruding or extending from sides of the bottom plate so that the bottom chassis 410 receives the mold frame assembly, the backlight assembly 300, and the LCD panel 200. The reflecting plate 430 is provided or sandwiched between the backlight assembly 300 and the bottom chassis 410 to reflect a portion of the visible light from the reflecting plate 430. It is understood that the bottom chassis 410 and the top chassis 420 refer to top/bottom structure frames, top/bottom foundations, top/bottom structural support members, over carriage/under carriage, etc.

According to the above-described embodiment of the invention, the reflecting plate 430 is provided under the low mold frame 510. An opening is provided on a central portion or area of the top chassis 420. The top chassis 420 has a quadrangular frame shape and is provided on or directly on the LCD panel to secure the LCD panel 200.

The mold frame assembly includes at least the low mold frame 510, the middle mold frame 520, and a spacer 550. The low mold frame 510 is provided or sandwiched between the bottom chassis 410, which has the reflecting plate 430, and the backlight assembly 300 to support or secure the backlight assembly 300. The low mold frame 510 includes at least a plurality of sidewalls and an opening.

According to an embodiment of the invention, the low mold frame 510 includes a stepped portion 512 for an optical sheet to receive the optical film assembly 320 on a lower surface of the stepped portion 512. Alternatively, an auxiliary spacer (not shown) may be provided between the lower surface of the stepped portion 512 and the diffusion plate 322.

The middle mold frame 520, which is provided or sandwiched between the optical film assembly 320 and the LCD panel 200, secures the optical film assembly 320 and supports the LCD panel 200. The middle mold frame 520 includes a plurality of sidewalls and an opening formed by the sidewalls. According to an embodiment of the invention, the middle mold frame 520 includes a lower stepped portion and a stepped portion 522 for the LCD panel such that the optical film assembly 320 is fixed by the lower stepped portion.

The spacer 550 is provided or sandwiched between a lower surface of the stepped portion 522 for the LCD panel and the LCD panel 200. Alternatively, the spacer 550 may be provided or sandwiched between a lower surface of a stepped portion (not shown) for the optical film assembly and the optical film assembly 320. The spacer 550 may be made of a rubber tape, a silicone resin, a synthetic rubber, etc. The spacer 550 is securely attached onto or with a lower surface of the stepped portion 522 for the LCD panel. A frictional force of the spacer 550 is sufficient to fix or secure the LCD panel 200. Alternatively, the spacer 550 may be provided or sandwiched between the LCD panel 200 and the bottom chassis 410.

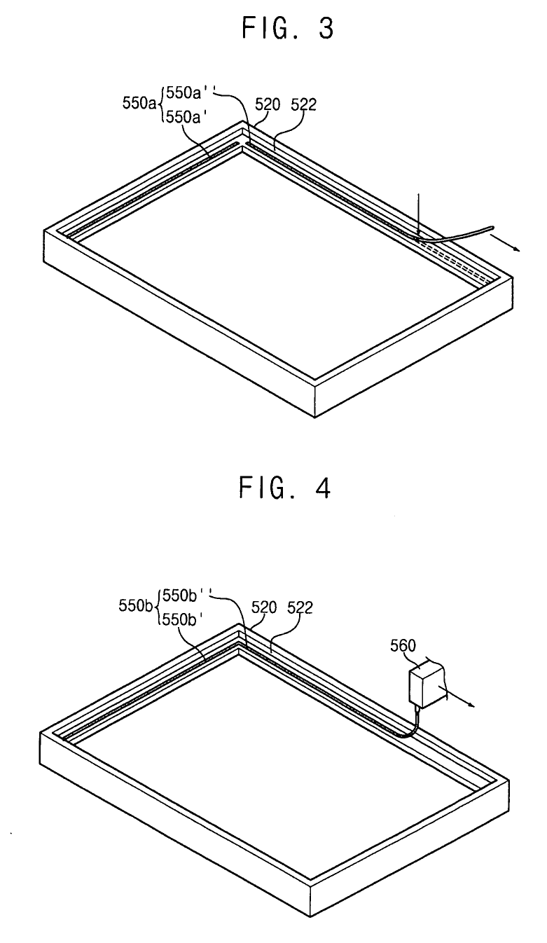

FIG. 3 is a perspective view showing a method of attaching a rubber tape to a middle mold frame shown in FIG. 1. Referring to FIG. 3, the spacer 550 is made of, for example, the rubber tape 550a. The rubber tape 550a includes an adhesive (not shown) and a rubber layer that is on the adhesive.

The rubber tape 550a is sized according to dimensions of the middle mold frame 520, for example, the rubber tape 550a is sized or cut according to side lengths of the middle mold frame 520. The rubber tape 550a includes, for example, a first rubber tape piece 550a′, a second rubber tape piece 550a″, a third rubber tape piece (not shown) and a fourth rubber tape piece (not shown). The first, second, third, and fourth rubber tape pieces 550a′ and 550a″ correspond to the sidewalls of the middle mold frame 520. The first, second, third and fourth rubber tape pieces 550a′ and 550a″ are spaced apart from each other and not overlapped with each other. As a result, an impurity may flow into a space provided between the LCD panel 200 and the backlight assembly 300.

In this exemplary embodiment, the rubber tape 550a is physically attached to or on the lower surface of the stepped portion 522 for the LCD panel 200. For example, the rubber tape 550a may attached by a worker or machine during assembly. For example, when the rubber tape 550a is attached onto or with the lower surface of the stepped portion 522 for the LCD panel by an automation system for the rubber tape 550a, the automation system for the rubber tape 550a may include a cutting device for cutting the rubber tape, an adhesion unit, a compressor, etc., so that size, complexity, and cost of the automation system for the rubber tape 550a and manufacturing cost of the LCD device are increased.

FIG. 4 is a perspective view showing a method of coating a silicone resin on a middle mold frame as shown in FIG. 1. Referring to FIG. 4, the spacer 550 includes, for example, a silicone resin spacer 550 b. A silicone resin is coated or applied on a lower surface of the stepped portion 522 for the LCD panel 200 by a silicon resin coating unit 560.

The silicone resin includes, for example, an organic silicone polymeric material. The silicone resin is coated on or applied to the lower surface of the stepped portion 522 for the LCD panel 200. The silicone resin spacer 550b includes, for example, a first silicone resin piece 550b′, a second silicone resin piece 550b″, a third silicone resin piece (not shown) and a fourth silicone resin piece (not shown). The first, second, third and fourth silicone resin pieces 550b′ and 550b″ correspond to the sidewalls of the middle mold frame 520. When the silicone resin is coated or applied on the lower surface of the stepped portion 522 for the LCD panel, the first, second, third and fourth silicone resin pieces 550b′ and 550b″ are connected with each other to prevent an inflow of an externally provided impurity into a space between the LCD panel 200 and the backlight assembly 300.

When end portions of the coated silicone resin are overlapped with each other, the coated silicone resin typically has non-uniform height. Thus, in the above-described embodiment of the invention, the end portions of the coated silicone resin are not overlapped with each other and the coated silicone resin has a uniform height.

The coated silicone resin is aged and solidified for a sufficient period of time to form the silicone resin spacer 550b. For example, the coated silicone resin may be solidified for eight hours to form the silicon resin spacer 550b. Therefore, when the LCD device includes the silicone resin spacer 550b, the manufacturing processes of the LCD device must include the aging process. Although the coated silicone resin is aged, the solidified silicone resin is not resistant and the silicone resin remains fluid.

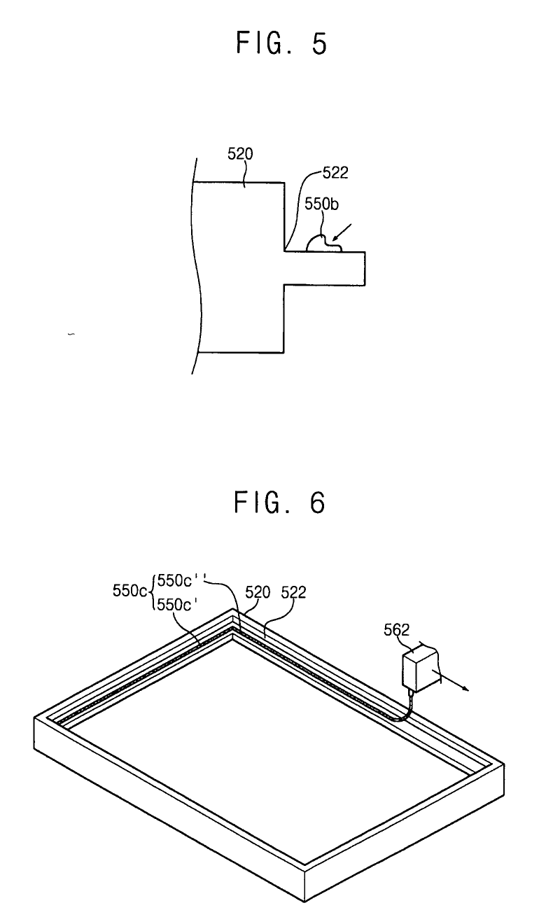

FIG. 5 is a cross-sectional view showing a deformation of the silicone resin shown in FIG. 4. Referring to FIG. 5, when the silicone resin spacer 550b is pressed, the silicone resin spacer 550b deforms and has an irregular height. A distance between the LCD panel 200 and the backlight assembly 300 or between the LCD panel 200 and the top chassis 420 changes when the silicon resin spacer 550b is deformed by external impact.

FIG. 6 is a perspective view showing a method of coating a synthetic rubber on a middle mold frame shown in FIG. 1. Referring to FIG. 6, the spacer 550 includes a synthetic rubber spacer 550c. A synthetic rubber is coated on a lower surface of the stepped portion 522 for the LCD panel 200 by a synthetic rubber coating unit 562. The synthetic rubber includes, for example, at least one of polyurethane resin, neoprene resin, butadiene resin, graft resin, diene resin, etc.

According to the embodiment of the invention shown in FIG. 6, the synthetic rubber includes polyurethane resin. The polyurethane resin is formed by a urethane bond. The urethane bond is formed by a reaction between a hydroxyl group (—OH) and an isocyanate group (—NCO). An organic polymer such as, for example, polyester, polyether, etc., forms the urethane resin. When the urethane resin forms from the polyester, the polyester reacts with naphthaline-1,5-diisocynate to form the urethane resin. When the urethane resin forms from the polyether, the polyether reacts with toluylenediisocynate to form the urethane resin. The urethane resin forms by following the reaction represented by Formula 1, shown hereinbelow:

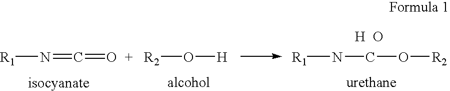

According to an embodiment of the invention, the polyurethane resin forms from polyisocynate, polyols and additives. The polyisocynate includes, for example, methylene diphenyl isocyante (MDI), toluene diisocynate (TDI), etc. Formula 2, shown hereinbelow, represents the MDI:.

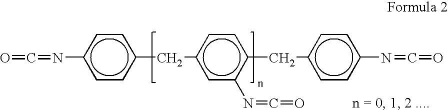

Formula 3, shown hereinbelow, represents the TDI:.

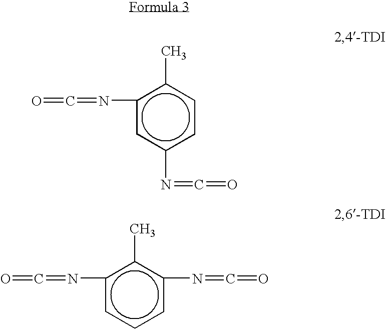

According to the above-described embodiment of the invention, the 2,4′-TDI and the 2,6′-TDI are mixed at a ratio of approximately 8:2.

The polyols include, for example, polyether polyol, polyester polyol, etc.

The polyether polyol forms from dipropylene glycol (DPG), propylene oxide and water. The polyether polyol forms by a reaction represented by Formula 4, shown hereinbelow:

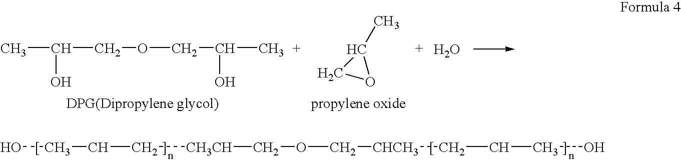

The addictives include, for example, a surfactant, a catalyst, a foaming agent, a crosslinking agent, a flame retardant, a filler, an antioxidant, etc. The surfactant stabilizes the polyurethane resin. The catalyst accelerates the urethane combination. The foaming agent vesicates or blisters the polyurethane resin. Alternatively, the foaming agent may be omitted.

The polyurethane resin securely adheres to the middle mold frame 520, and has a high coefficient of friction.

The neoprene resin forms by chloroprene polymerization. The butadiene resin forms by butadiene polymerization using heat, oxygen, etc. The graft resin forms by polybutadiene, styrene and acrylonitrile, copolymerization.

The synthetic rubber spacer 550c includes, for example, a first synthetic rubber piece 550c′, a second synthetic rubber piece 550c″, a third synthetic rubber piece (not shown) and a fourth synthetic rubber piece (not shown). The first, second, third and fourth synthetic rubber pieces 550c′ and 550c″ correspond to the sidewalls of the middle mold frame 520, respectively. The synthetic rubber is coated on the lower surface of the stepped portion 522 for the LCD panel such that the first, second, third and fourth synthetic rubber pieces 550c′ and 550c″ connect with each other to prevent an impurity from entering into a space between the LCD panel 200 and the backlight assembly 300. The impurity may be externally provided, such as through airborne particles. As shown in FIG. 6, for example, end portions of the coated synthetic rubber are not overlapped with each other, thereby creating a uniform height for the coated synthetic rubber. Therefore, the height of synthetic rubber spacer 550c is uniform.

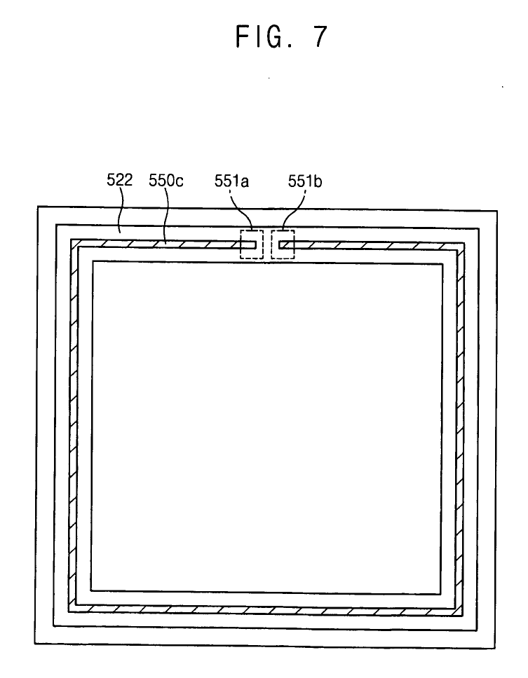

FIG. 7 is a plan view showing the coated synthetic rubber according to an embodiment of the invention. Referring to FIG. 7, a first end portion 551a of the coated polyurethane resin and a second end portion 551b of the coated polyurethane resin are provided on or directly on the lower surface of the stepped portion 522 for the LCD panel. Thus, in a non-limiting example shown in FIG. 7, the first end portion 551a and the second end portion 551b are spaced apart from each other.

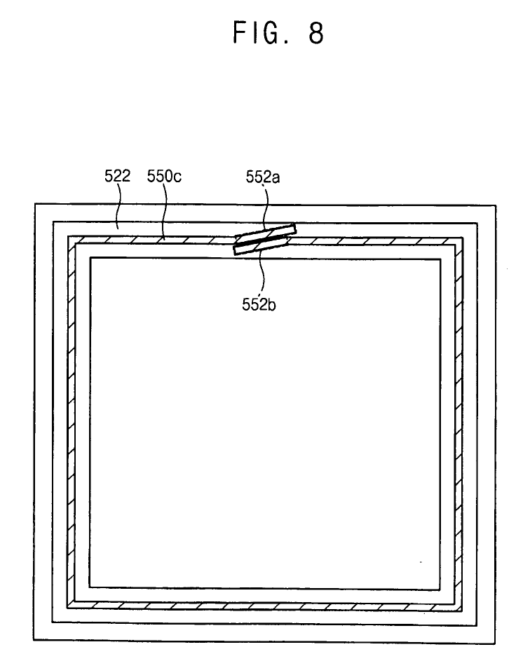

FIG. 8 is a plan view showing the coated synthetic rubber according to another embodiment of the invention. Referring to FIG. 8, a first end portion 552a of the coated polyurethane resin and a second end portion 552b of the coated polyurethane resin are provided on or directly on the lower surface of the stepped portion 522 for the LCD panel. Thus, in a non-limiting example shown in FIG. 8, the first end portion 552a is substantially parallel with the second end portion 552b. Since the first end portion 552a and the second end portion 552b are parallel with each other, e.g., an end portion of the first end portion 552a faces an end portion of the second end portion 552b, a path length between each said end portion 552a and 552b is at a sufficient length to decrease an amount of impurity entering or flowing into a space between the LCD panel and the optical film assembly. The impurity may be an airborne particle from an environment that is external to the liquid crystal display device.

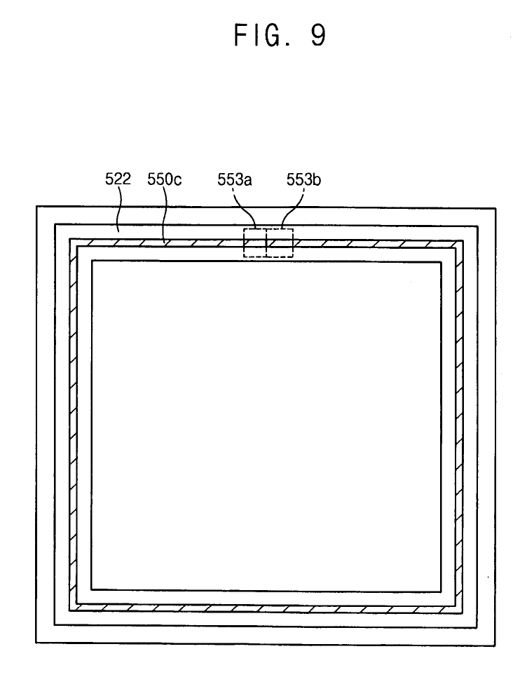

FIG. 9 is a plan view showing the coated synthetic rubber according to another embodiment of the invention. Referring to FIG. 9, a first end portion 553a of the coated polyurethane resin and a second end portion 553b of the coated polyurethane resin are provided on or directly on the lower surface of the stepped portion 522 for the LCD panel. Thus, in a non-limiting example shown in FIG. 9, the first end portion 553a and the second end portion 553b contact each other, preventing or decreasing an amount of impurity entering or flowing into a space between the LCD panel and the optical film assembly. As previously discussed, the impurity may be externally provided, such as an airborne particle.

The synthetic rubber spacer 550c is formed by aging and solidifying the coated polyurethane resin for a sufficient period of time. In a non-limiting example, the coated polyurethane resin, is aged and solidified for many minutes to form the synthetic rubber spacer 550c. According to the embodiment shown in FIG. 9, the coated synthetic rubber is solidified for approximately four minutes, which is a shorter time period than the solidification of the silicone resin. Therefore, LCD devices with a synthetic rubber spacer 550c have a reduced manufacturing process time than LCD devices with a silicon resin spacer 550c.

The synthetic rubber spacer 550c has a higher frictional force than the silicone resin spacer 550b thereby preventing drifting or moving of the LCD panel 200. Additionally, an adhesive strength between the synthetic rubber spacer 550c and the middle mold frame 520 is larger than an adhesive strength between the silicone resin spacer 550b and the middle mold frame 520.

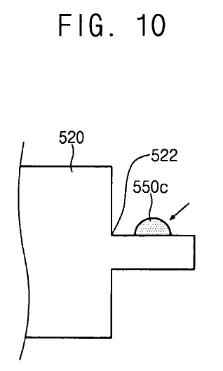

FIG. 10 is a cross-sectional view showing the coated synthetic rubber upon being pressed, for example, by an external impact. The solidified synthetic resin is sufficiently elastic such that it is resistant against an externally provided force. Referring to FIG. 10, the synthetic rubber spacer 550c has a uniform height and does not deform when pressed by an external force. The material and shape of the synthetic rubber spacer 550c enable the synthetic rubber spacer 550c to absorb on the externally provided impact, thereby protecting the LCD panel 200.

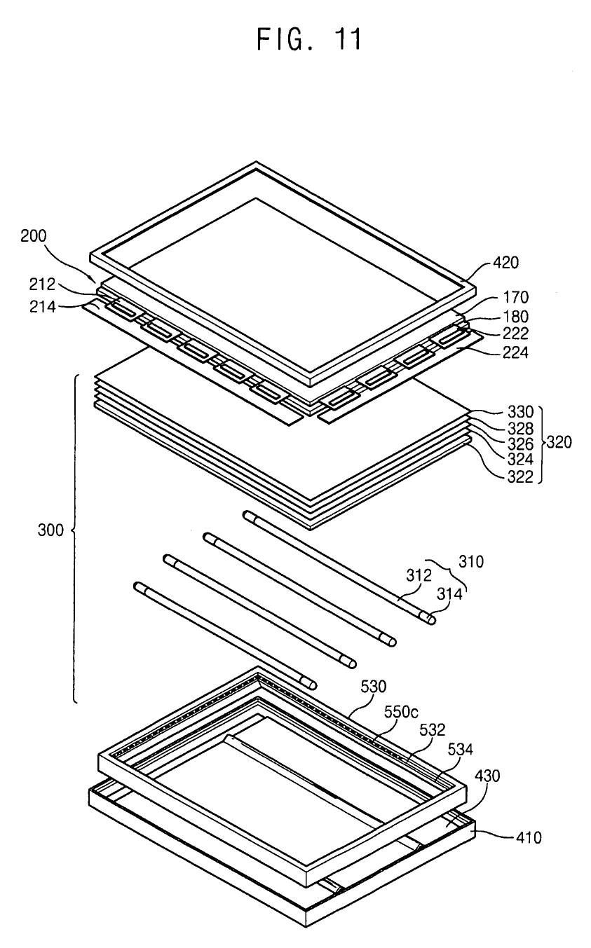

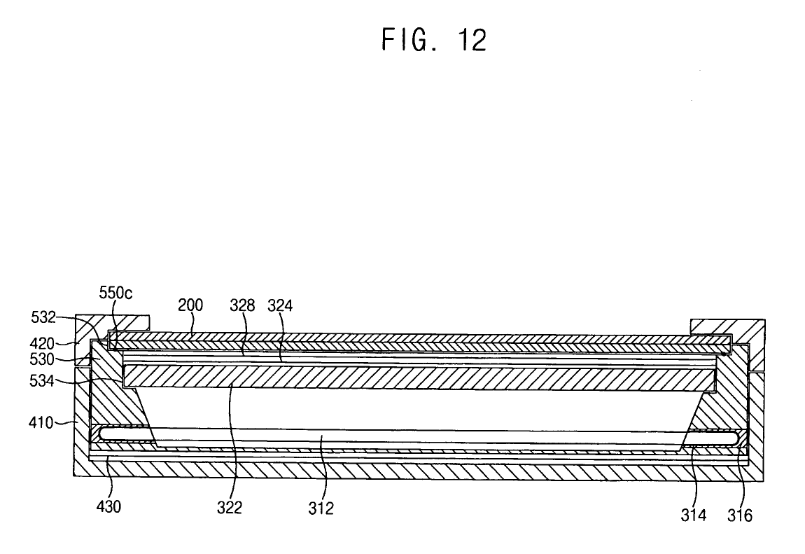

FIG. 11 is an exploded perspective view showing an LCD device according to another embodiment of the invention. FIG. 12 is a cross-sectional view showing an LCD device shown in FIG. 11. The LCD device of FIG. 11 and FIG. 12 is same as the LCD device shown in FIG. 1 and FIG. 2, except that the embodiments shown in FIG. 1 and FIG. 2 do not include a mold frame assembly. Thus, the same reference numerals are used to refer to the same and/or similar parts as those described in FIG. 1 and FIG. 2 and any further explanation concerning the above elements is omitted.

Referring to FIG. 11 and FIG. 12, the LCD device includes an LCD panel 200, a backlight assembly 300, a mold frame assembly and a chassis assembly. The LCD panel 200 includes at least a first substrate 170, a second substrate 180, a liquid crystal layer (not shown), a data TCP 212, a data PCB 214, a gate TCP 222, and a gate PCB 224.

The backlight assembly 300 is provided on or directly on a rear surface of the LCD panel 200. The backlight assembly 300 includes at least a lamp 310, a lamp socket 316, and an optical film assembly 320. The lamp 310 includes at least a lamp body 312 and a lamp electrode 314. The lamp body 312 includes at least a discharge space (not shown), a fluorescent layer (not shown), and a discharge gas (not shown) provided in the discharge space (not shown). The lamp socket 316 is provided or secured in a mold frame 530.

A visible light generated from the lamp 310 is converted into a planar light by the optical film assembly 320, which is provided on or directly on the lamp 310, and improves optical characteristics of the visible light. The optical film assembly 320 includes at least a diffusion plate 322, a diffusion sheet 324, a lower prism sheet 326, an upper prism sheet 328, and a protecting sheet 330.

The chassis assembly includes at least a bottom chassis 410, a top chassis 420, and a reflecting plate 430. The bottom chassis 410 receives or holds the mold frame assembly, the backlight assembly 300 and the LCD panel 200. The reflecting plate 430 is provided or sandwiched between the backlight assembly 300 and the bottom chassis 410. The top chassis 420 fixes, holds, secures, etc., the LCD panel 200 and is provided on or directly on the LCD panel 200.

FIG. 13 is a cross-sectional view showing a mold frame assembly as shown in FIG. 11. Referring to FIG. 11, FIG. 12, and FIG. 13, the mold frame assembly includes the mold frame 530 and a synthetic rubber spacer 550 c.

The mold frame 530 supports the backlight assembly 300 and the LCD panel 200 and is provided or sandwiched between the bottom chassis 410 having the reflecting plate 430 thereon and the backlight assembly 300. The mold frame 530 includes a plurality of sidewalls and an opening that is defined or shaped by the sidewalls. The mold frame 530 shown in FIG. 11, FIG. 12, and FIG. 13 includes a first stepped portion 532 and a second stepped portion 534 and the optical film assembly 320 is provided on or directly on a lower surface of the second stepped portion 534.

The synthetic rubber spacer 550c is provided or sandwiched between a lower surface of the first stepped portion 532 and the LCD panel 200. A frictional force of the synthetic rubber spacer 550c is sufficient to fix, secure or hold the LCD panel 200.

The synthetic rubber spacer 550c is formed with a polyurethane resin. The synthetic rubber spacer 550c includes a first synthetic rubber piece 550c′, a second synthetic rubber piece 550c″, a third synthetic rubber piece (not shown) and a fourth synthetic rubber piece (not shown). The first, second, third and fourth synthetic rubber pieces 550c′ and 550c″ correspond to the sidewalls of the mold frame 530, respectively. The synthetic rubber is coated on the lower surface of the first stepped portion 532 such that the first, second, third and fourth synthetic rubber pieces 550c′ and 550c″ are connected with each other, thereby preventing or reducing the probability that an impurity will flow into a space located between the LCD panel 200 and the backlight assembly 300. Therefore, as shown in FIG. 13, the coated synthetic rubber has a uniform height since end portions of the coated synthetic rubber are not overlapped with each other.

According to the embodiment discussed above, the mold frame assembly supports and secures the LCD panel 200 and includes the mold frame 530 and the synthetic rubber spacer 550c. In addition, the synthetic rubber spacer 550c protects the LCD panel 200 from an external impact.

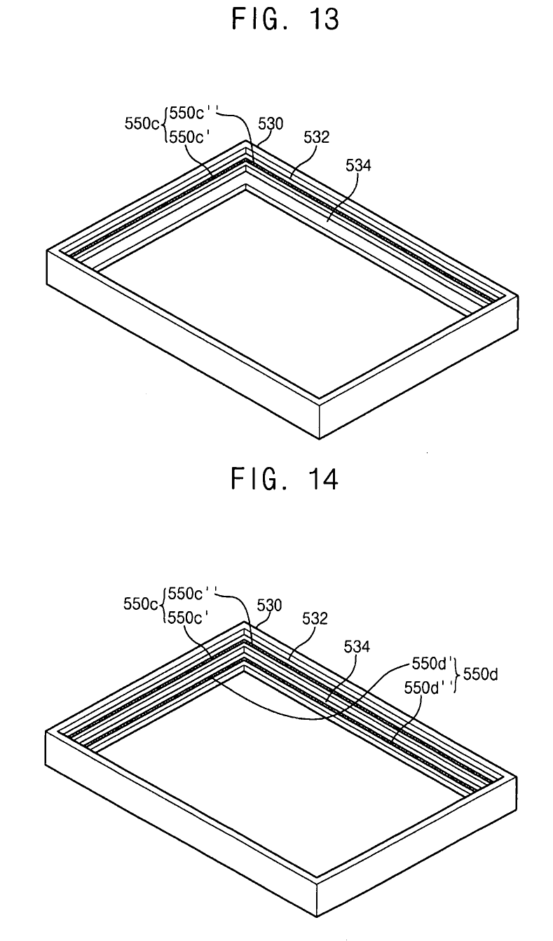

FIG. 14 is a perspective view showing a mold frame assembly according to an embodiment of the invention. The LCD device of FIG. 14 is the same or substantially similar as the LCD device shown in FIG. 1 and FIG. 2, except that the embodiments shown in FIG. 1 and FIG. 2 do not include a mold frame assembly. Thus, the same reference numerals are used to refer to the same and/or similar parts as those described in FIG. 1 and FIG. 2 and any further explanation concerning the above elements is omitted.

Referring to FIG. 11, FIG. 12 and FIG. 14, the mold frame assembly includes a mold frame 530, a synthetic rubber spacer 550c and an auxiliary synthetic rubber spacer 550d.

The mold frame 530 supports the backlight assembly 300 and the LCD panel 200 and is provided or sandwiched between the bottom chassis 410 having the reflecting plate 430 and the backlight assembly 300. The mold frame 530 includes a plurality of sidewalls and an opening defined or shaped by the sidewalls. As shown in the embodiment shown in FIG. 11, FIG. 12, and FIG. 14, the mold frame 530 includes a first stepped portion 532 and a second stepped portion 534.

The synthetic rubber spacer 550c holds, supports, secures, etc., the LCD panel 200 and is provided between a lower surface of the first stepped portion 532 and the LCD panel 200. The synthetic rubber spacer 550c includes a first synthetic rubber piece 550c′, a second synthetic rubber piece 550c″, a third synthetic rubber piece (not shown), and a fourth synthetic rubber piece (not shown). The first, second, third and fourth synthetic rubber pieces 550c′ and 550c″ correspond to the sidewalls of the mold frame 530, respectively. The synthetic rubber is coated on the lower surface of the first stepped portion 532 such that the first, second, third and fourth synthetic rubber pieces 550c′ and 550c″ are connected with each other, thereby preventing or reducing the probability that an impurity will flow into a space located between the LCD panel 200 and the backlight assembly 300.

The auxiliary synthetic rubber spacer 550 d supports and secures the optical film assembly 320 and is provided between a lower surface of the second stepped portion 534 and the optical film assembly 320. The auxiliary synthetic rubber spacer 550d includes a first auxiliary synthetic rubber piece 550d′, a second auxiliary synthetic rubber piece 550d″, a third auxiliary synthetic rubber piece (not shown), and a fourth auxiliary synthetic rubber piece (not shown). The first, second, third and fourth auxiliary synthetic rubber pieces 550d′ and 550d″ correspond to the sidewalls of the mold frame 530, respectively. The synthetic rubber is coated on the lower surface of the second stepped portion 534 such that the first, second, third, and fourth auxiliary synthetic rubber pieces 550d′ and 550d″ are connected with each other, thereby preventing or reducing the probability that an impurity will flow into the backlight assembly 300.

The synthetic rubber spacer 550c and the auxiliary synthetic rubber spacer 550d both include polyurethane resin. A polyurethane coating unit (not shown) coats the polyurethane resin on the first stepped portion 532 such that there is no overlapping of end portions of the polyurethane resin coated on the first stepped portion 532. Additionally, the polyurethane coating unit (not shown) coats the polyurethane resin on the second stepped portion 534 such that there is no overlapping of end portions of the coated polyurethane resin on the second stepped portion 534.

According to the above-described embodiment of the invention, the mold frame assembly supports and secures the LCD panel 200 and the optical film assembly 320, and includes the mold frame 530, the synthetic rubber spacer 550c and the auxiliary synthetic rubber spacer 550d. In addition, the synthetic rubber spacer 550c and the auxiliary synthetic rubber spacer 550d absorb impact, thereby protecting the LCD panel 200 and the optical film assembly 320 from an external impact.

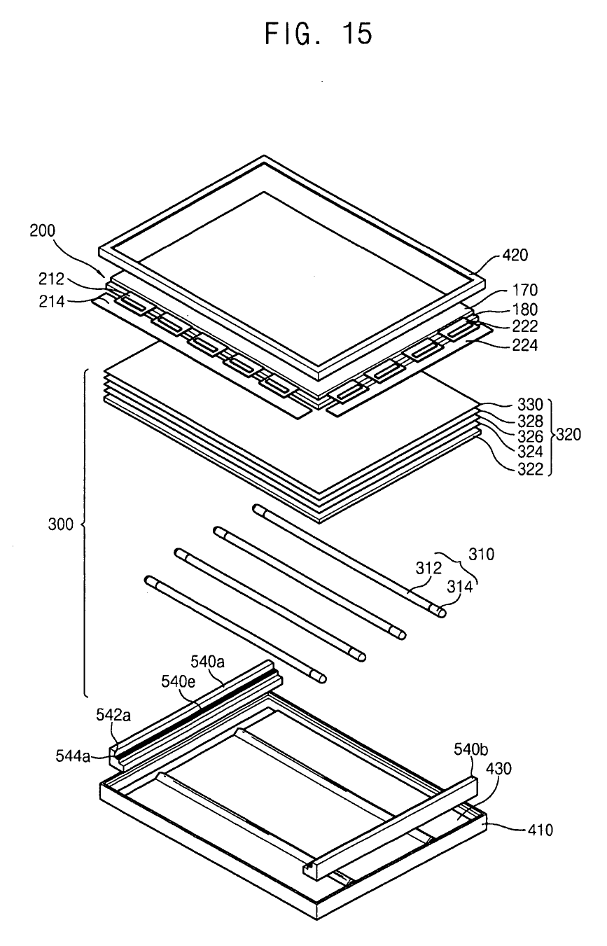

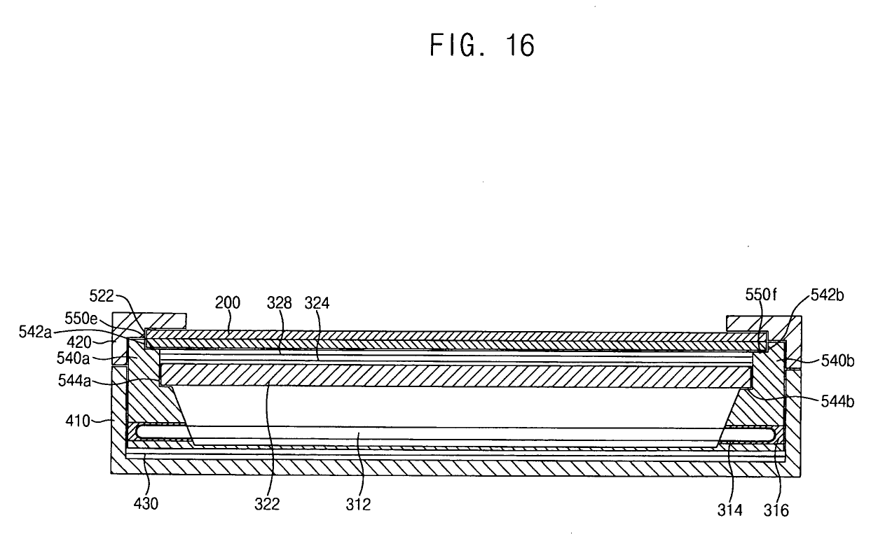

FIG. 15 is a perspective view showing an LCD device according to an embodiment of the invention. FIG. 16 is a cross-sectional view of an LCD device shown in FIG. 15. The LCD device of FIG. 15 and FIG. 16 is the same or substantially similar to the LCD devices shown in FIG. 1 and FIG. 2, except that the LCD devices of FIG. 1 and FIG. 2 do not include a mold frame assembly. Thus, the same reference numerals will be used to refer to the same and/or similar parts as those described in FIG. 1 and FIG. 2 and any further explanation concerning the elements described above is omitted.

Referring to FIG. 15 and FIG. 16, the LCD device includes an LCD panel 200, a backlight assembly 300, a mold frame assembly, and a chassis assembly. The LCD panel 200 includes a first substrate 170, a second substrate 180, a liquid crystal layer (not shown), a data TCP 212, a data PCB 214, a gate TCP 222, and a gate PCB 224. The backlight assembly 300 is provided on or directly on a rear surface of the LCD panel 200 and includes a lamp 310, a lamp socket 316, and an optical film assembly 320.

The lamp 310 includes a lamp body 312 and a lamp electrode 314. The lamp body 312 includes a discharge space (not shown), a fluorescent layer (not shown), and a discharge gas (not shown) provided in the discharge space (not shown). The lamp socket 316 is provided or secured with a first piece mold 540a and a second piece mold 540b. The first and second mold pieces 540a and 540b are not limited to the structure shown in FIG. 15, and may include grooved supports, notched supports, supports having tracks and the like.

The optical film assembly 320 is provided on or directly on the lamp 310 and converts a light generated from the lamp 310 into a planar light. The optical film assembly 320 includes a diffusion plate 322, a diffusion sheet 324, a lower prism sheet 326, an upper prism sheet 328, and a protecting sheet 330.

The chassis assembly includes a bottom chassis 410, a top chassis 420, and a reflecting plate 430. The bottom chassis 410 receives, secures, or holds the mold frame assembly, the backlight assembly 300, and the LCD panel 200. The reflecting plate 430 is provided between the bottom chassis 410 and the first and second piece molds 540a and 540b. The top chassis 420 fixes, holds, secures, etc., the LCD panel 200 and is provided on or directly on the LCD panel 200.

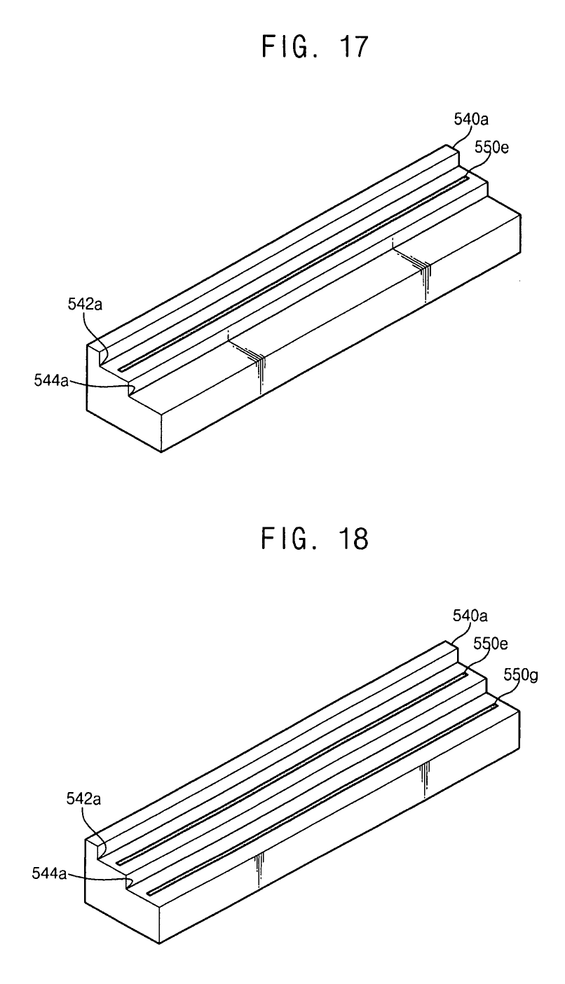

FIG. 17 is a perspective view of a first piece mold and a first synthetic rubber spacer shown in FIG. 15. Referring to FIGS. 15, 16 and 17, the mold frame assembly includes the first piece mold 540a, the second piece mold 540b, a first synthetic rubber spacer 550e, and a second synthetic rubber spacer 550f.

The first and second piece molds 540a and 540b support the backlight assembly 300 and the LCD panel 200 and are provided between the bottom chassis 410 and the backlight assembly 300. The second piece mold 540b corresponds with the first piece mold 540a and each of the first and second piece molds 540a and 540b is rod shaped. As shown in FIG. 16, for example, the first piece mold 540a includes a first stepped portion 542a and a second stepped portion 544a, and the second piece mold 540b includes a third stepped portion 542b and a fourth stepped portion 544b. The optical film assembly 320 is provided on or directly on lower surfaces of the second and fourth stepped portions 544a and 544b.

The first synthetic rubber spacer 550e is provided between a lower surface of the first stepped portion 542a and the LCD panel 200, and the second synthetic rubber spacer 550f is provided between a lower surface of the third stepped portion 542b and the LCD panel 200. The frictional forces of the first and second synthetic rubber spacers 550e and 550f is sufficient to fix, secure, hold, etc., the LCD panel 200.

The first and second synthetic rubber spacers 550e and 550f each have a polyurethane resin.

According to the above-described embodiment of the invention, the mold frame assembly supports and secures the LCD panel 200 and includes the first and second piece molds 540a and 540b and the first and second synthetic rubber spacers 550e and 550f. The first and second synthetic rubber spacers 550e and 550f also protect the LCD panel 200 from shifting or moving due to an external impact.

FIG. 18 is a perspective view of a mold frame assembly of an LCD device showing a first piece mold, a first synthetic rubber spacer, and a first auxiliary synthetic rubber spacer according to an embodiment of the invention. The LCD device of FIG. 18 is same as the LCD device shown in FIGS. 15, 16 and 17, except that the LCD device shown in FIGS. 15, 16 and 17 do not include a first auxiliary spacer and a second auxiliary spacer. Thus, the same reference numerals will be used to refer to the same and/or similar parts as those described in FIGS. 15, 16, and 17 and any further explanation concerning the above-described elements is omitted.

Referring to FIGS. 15, 16 and 18, the mold frame assembly includes the first piece mold 540a, the second piece mold 540b, a first synthetic rubber spacer 550e, a second synthetic rubber spacer 550f, a first auxiliary synthetic rubber spacer 550g, and a second auxiliary synthetic rubber spacer (not shown).

The first and second piece molds 540a and 540b support and secure the backlight assembly 300 and the LCD panel 200 and are provided between the bottom chassis 410 and the backlight assembly 300. The second piece mold 540b corresponds to the first piece mold 540a. Each of the first and second piece molds 540a and 540b is rod shaped. According to the embodiment shown in FIG. 18, for example, the first piece mold 540a includes a first stepped portion 542a and a second stepped portion 544a, and the second piece mold 540b includes a third stepped portion 542b and a fourth stepped portion 544b.

The first synthetic rubber spacer 550e is provided between a lower surface of the first stepped portion 542a and the LCD panel 200, and the second synthetic rubber spacer 550f is provided between a lower surface of the third stepped portion 542b and the LCD panel 200. Frictional force of the first and second synthetic rubber spacers 550e and 550f is sufficient to fix, secure, hold, etc., the LCD panel 200 with the mold frame assembly.

The first auxiliary synthetic rubber spacer 550g is provided between a lower surface of the second stepped portion 544a and the optical film assembly 320. The second auxiliary synthetic rubber spacer (not shown) is interposed between a lower surface of the fourth stepped portion 544b and the optical film assembly 320. The frictional forces of the first and second auxiliary synthetic rubber spacers 550g is sufficient enough to fix, secure, hold, etc., the optical film assembly 320 with the mold frame assembly.

The first and second synthetic rubber spacers 550e and 550f and the first and second auxiliary synthetic rubber spacers 550g each have a polyurethane resin.

According to the above-described embodiment of the invention, for example, the mold frame assembly supports and secures the LCD panel 210 and the optical film assembly 320 with the mold frame assembly of the LCD device and includes the first and second piece molds 540a and 540b, the first and second synthetic rubber spacers 550e and 550f, and the first and second auxiliary synthetic rubber spacers 550g. The first and second synthetic rubber spacers 550e and 550f protect the LCD panel 200 from an external impact. The first and second auxiliary synthetic rubber spacers 550g protect the optical film assembly 320 from such external impact.

According to an embodiment of the invention, the first and second synthetic rubber spacers 550e and 550f, and the first and second auxiliary synthetic rubber spacers 550g are formed with synthetic rubber, which solidifies more rapidly and has a greater coefficient of fraction than silicone resin, and supports and secures the LCD panel with the mold frame assembly of the LCD device. Further, the synthetic rubber spacer is sufficiently elastic to protect the LCD device from an external impact by absorbing such impact and recovering its original shape.

The spacer may be sequentially formed, using an automation system, so that manufacturing time manufacturing cost are reduced. In addition, coating synthetic rubber on the mold frame prevents or reduces the probability of an impurity flowing or entering between the LCD panel and the backlight assembly. Further, forming the synthetic rubber spacer with polyurethane resin strengthens the adhesion between the synthetic rubber spacer and the mold frame and increases the frictional force between the synthetic rubber spacer and the LCD panel.

The optical film assembly 320 may be supported and secured to the mold frame assembly of the LCD device by including an auxiliary synthetic rubber spacer 550g between a surface of a stepped portion and the optical film assembly 320.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A receiving container for a display device comprising:
a frame; and
a synthetic rubber spacer provided on the frame,
wherein the synthetic rubber spacer comprises a plurality of synthetic rubber pieces that are connected together.

2. The receiving container of claim 1, wherein the frame further comprises:
a plurality of sidewalls defining an open area of the receiving container and having a stepped portion,
wherein the synthetic rubber spacer is provided on a lower level surface area of the stepped portion.

3. The receiving container of claim 2, wherein each of the sidewalls comprises an auxiliary stepped portion.

4. The receiving container of claim 3, further comprising:
an auxiliary synthetic rubber spacer provided on the auxiliary stepped portion,
wherein the auxiliary synthetic rubber spacer comprises a plurality of auxiliary synthetic rubber pieces that are connected together.

5. The receiving container of claim 1, wherein the synthetic rubber spacer comprises at least one selected from the group consisting of polyurethane resin, neoprene resin, butadiene resin, graft resin, and diene resin.

6. A liquid crystal display device comprising:
a backlight assembly generating a light;
a liquid crystal display panel provided on the backlight assembly that displays an image using the generated light;
a receiving container provided between the backlight assembly and the liquid crystal display panel to secure the backlight assembly, the receiving container including a plurality of sidewalls that define an open area of the receiving container; and
a synthetic rubber spacer provided between the sidewalls and the liquid crystal display panel to support the liquid crystal display panel,
wherein the synthetic rubber spacer comprises a plurality of synthetic rubber pieces connected together.

7. The liquid crystal display device of claim 6, wherein the synthetic rubber spacer comprises at least one selected from the group consisting of polyurethane resin, neoprene resin, butadiene resin, graft resin and diene resin.

8. The liquid crystal display device of claim 6, wherein each of the sidewalls comprises:
a stepped portion such that the synthetic rubber spacer is provided on a lower level surface area of the stepped portion of each of the sidewalls.

9. A liquid crystal display device comprising:
a backlight assembly generating a light;
a liquid crystal display panel provided on the backlight assembly that displays an image using the generated light;
a receiving container, which receives the liquid crystal display panel and the backlight assembly, and comprises a plurality of sidewalls that define an open area of the receiving container; and
a synthetic rubber spacer provided between the sidewalls and the liquid crystal display panel to support the liquid crystal display panel,
wherein the synthetic rubber spacer comprises a plurality of synthetic rubber pieces that are connected together.

10. The liquid crystal display device of claim 9, wherein the synthetic rubber spacer comprises at least one selected from the group consisting of polyurethane resin, neoprene resin, butadiene resin, graft resin, and diene resin.

11. The liquid crystal display device of claim 9, wherein each of the sidewalls comprises:
a first stepped portion and a second stepped portion such that each of the synthetic rubber pieces is provided on a lower level surface area of the first stepped portion.

12. The liquid crystal display device of claim 11, wherein the backlight assembly is provided on a lower level surface area of the second stepped portion.

13. The liquid crystal display device of claim 11, further comprising:
an auxiliary synthetic rubber spacer provided between the lower level surface area of the second stepped portion and the backlight assembly,
wherein the auxiliary synthetic rubber spacer comprises a plurality of auxiliary synthetic rubber pieces connected together.

14. A liquid crystal display device comprising:
a backlight assembly that generates a light;
a liquid crystal display panel provided on the backlight assembly to display an image using the generated light;
a receiving container, which receives the backlight assembly and the liquid crystal display panel, and includes a first rod shaped piece and a second rod shaped piece corresponding to the first rod shaped piece;
a synthetic rubber spacer provided between the first rod shaped piece and the liquid crystal display panel that supports the liquid crystal display panel; and
a second synthetic rubber spacer provided between the second rod shaped piece corresponding to the first rod shaped piece and the liquid crystal display panel that supports the liquid crystal display panel.

15. The liquid crystal display device of claim 14, wherein each of the synthetic rubber spacers comprises at least one of polyurethane resin, neoprene resin, butadiene resin, graft resin, and diene resin.

16. The liquid crystal display device of claim 14, wherein the first rod shaped piece and second rod shaped piece corresponding to the first rod shaped piece comprise a first and a second stepped portion, and a third and a fourth stepped portion, respectively,
wherein the first synthetic rubber spacer and second synthetic rubber spacer are provided on a lower level surface area of the first stepped portion and a lower level surface area of the third stepped portion, respectively.

17. The liquid crystal display device of claim 16, wherein the backlight assembly is provided on a lower level surface area of the second stepped portion and a lower level surface area of the fourth stepped portion.

18. The liquid crystal display device of claim 16, further comprising:
an auxiliary synthetic rubber spacer provided between a lower surface of the second stepped portion and the backlight assembly; and
a second auxiliary synthetic rubber spacer interposed between a lower surface of the fourth stepped portion and the backlight assembly.

19. The liquid crystal display device of claim 14, wherein the first rod shaped piece and second rod shaped piece corresponding to the first rod shaped piece are a first mold piece and a second mold piece, respectively.

20. A method of manufacturing a liquid crystal display device, the method comprising:
forming a mold frame on a backlight assembly, the mold frame having a plurality of sidewalls that define an open area of the mold frame, each of the sidewalls having a stepped portion;
coating synthetic rubber resin on a lower level surface area of the stepped portion;
solidifying the coated synthetic resin; and
forming a liquid crystal display device on the solidified synthetic resin.

21. The method of claim 20, wherein the synthetic rubber resin is continuously coated on the lower level surface area of the stepped portions of the sidewalls.

22. The method of claim 20, wherein end portions of the coated synthetic rubber are spaced apart from each other.

23. The method of claim 20, wherein end portions of the coated synthetic rubber are substantially parallel with each other.

24. The method of claim 20, wherein end portions of the coated synthetic rubber contact each other.
